(19) United States
(12) Patent Application Publication
(10) Pub. No.: US 2017/0053364 A1
(43) Pub. Date: Feb. 23, 2017

(54) SYSTEM AND METHOD FOR CREATING AN ELECTRONICALLY STORED CONSENSUAL SEX AFFIRMATION

(71) Applicant: GERALD MARK, IRVINE, CA (US)

(72) Inventor: GERALD MARK, IRVINE, CA (US)

(21) Appl. No.: 15/208,533

(22) Filed: Jul. 12, 2016

Related U.S. Application Data
(60) Provisional application No. 62/206,164, filed on Aug. 17, 2015.

(51) Int. Cl. G06Q 50/18; H04L 12/58

(52) U.S. Cl. CPC G06Q 50/18; H04L 51/08

(57) ABSTRACT

The consensual sex affirmation storing system for creating an electronically stored sex affirmation consent, resides on a central computer having a processor installed with a consensual sex affirmation software application and coupled with a memory unit integrated with a central database. The central computer executes a computer readable program code embodied in a non-transitory computer-readable medium. The computer readable program code includes a set of instructions for executing a method for creating an electronically stored consensual sex affirmation between two individuals prior to the sexual activity. The consensual sex affirmation storing system further comprising, a welcome module, a consensual sex affirmation acknowledgement module, a user authorization module, an identification module, a verification module, a code generation module, a declaration module, a consensual sex affirmation sending module, and a consensual sex affirmation storage module.

### CROSS-REFERENCE TO RELATED APPLICATIONS

This application claims the benefit of U.S. Provisional Application No. 62/206,164 filed on Aug. 17, 2015.

### STATEMENT REGARDING FEDERALLY SPONSORED RESEARCH AND DEVELOPMENT

Not Applicable.

### FIELD OF THE DISCLOSURE

The present disclosure relates generally to software applications for electronically recording consent for an event. More specifically, the present disclosure relates to a system and method for creating an electronically stored consensual sex affirmation between two individuals before engaging in sexual activity.

### DISCUSSION OF RELATED ART

With the popularity and growth of social media, society has become increasingly aware of the number of incidents involving sexual assault. Additionally, the increase in reports of college campus assaults and the conflicting stories of the parties involved have also brought the issue of consent to the forefront. This increased awareness has resulted in increased pressure on higher education institutions to enact or modify policies for the handling of sexual assault complaints. One way to assist in this endeavour is to remove doubt from the issue of consent. To do this each party needs to make an affirmative, conscious and voluntary agreement to engage in consensual sexual activity prior to engaging in such activity.

The conventional method to document the consent of two individuals engaged in sexual activity is to maintain signed forms or complicated bio metrics systems. Such records are very difficult to maintain for long periods of time since they can be subject to physical damages due to wear and tear. If these methods are not available, or the situation doesn't require that level of documentation, then an individual is left with only a verbal agreement which can lead to the classic “he said-she said” situation where the statements contradict each other.

Another method describes a system for a consentee to obtain consent from a consenter. The consentee accesses a consentee profile having a primary photograph of the consentee to identify the consentee to the consenter and creates a new event record for obtaining and storing the consent from the consenter. The consenter records a non-editable video of himself or herself for a predetermined length of time. A unique code is displayed on a screen viewable by the consenter during the recording step in which the consenter is prompted to identify the unique code during the recording step to verify the consenter was alive and cognizant. A digital video consent signature is generated from the non-editable video and the digital video consent signature is stored in the new event record to be used as evidence to verify the consentee had consent from the consenter. Even so, this method is not flexible and may not clarify the ambiguity when it comes to the question of affirmative consent.

Therefore, there is a need for an application which allows a user to create an electronically stored consensual sex affirmation before engaging in sexual activity. Such a needed application would provide a facility that clarifies any ambiguity regarding the question of affirmative consent to sexual activity. This device would provide a simple and easy way for users to create new affirmations, view previously stored affirmations and to navigate through resource links to various organizations or websites offering healthcare information. Moreover this application would allow users to create a memorialized affirmation which will be stored within the application if internet connectivity is unavailable. The present embodiment overcomes prior art shortcomings by accomplishing these critical objectives.

### SUMMARY OF THE DISCLOSURE

To minimize the limitations found in the prior art, and to minimize other limitations that will be apparent upon the reading of the specification, the present invention is a system of creating an electronically stored sex affirmation consent between two individuals before engaging in sexual activity. In the preferred embodiment, a consensual sex affirmation storing system is in communication with at least one electronic portable communication device via a communication network. The consensual sex affirmation storing system resides on a central computer having a processor installed with a consensual sex affirmation software application and coupled with a memory unit integrated with a central database. The consensual sex affirmation storing system further comprising, a welcome module, a consensual sex affirmation acknowledgement module, a user authorization module, an identification module, a verification module, a code generation module, a declaration module, a consensual sex affirmation sending module, and a consensual sex affirmation storage module.

The method initiates by enabling a first individual to open the consensual sex affirmation software application utilizing a welcome module through at least one electronic portable communication device such as a smart phone, a laptop, a tablet computer and a hand-held digital media communication device. A continue button on a welcome screen of the consensual sex affirmation software application leads the first individual to the consensual sex affirmation acknowledgement process. During the consensual sex affirmation acknowledgement process, the first individual and a second individual accepts a plurality of terms to move forward with the process utilizing a consensual sex affirmation acknowledgement module. An authorization module authorizes whether the first individual is the owner of the at least one electronic portable communication device and stores a plurality of the contact details submitted by the first individual in the at least one electronic portable communication device to auto populate the consensual sex affirmation contact information form in future, if the first individual is the owner of the at least one electronic portable communication device. The method further proceeds by allowing the first individual and the second individual to complete and submit the plurality of contact details on a consensual sex affirmation contact information form utilizing an identification module. The plurality of contact details of the first individual and the second individual preferably comprises: first name, last name, gender, date of birth, mobile number and email address of the first individual and the second individual respectively. After submitting the plurality of contact details of both the first individual and the second individual, the system captures the likeness of the first individual and the second individual by enabling the first individual and the second individual to take a selfie photo together utilizing a verification module. Once the first individual and the second individual selects the selfie button, the likeness of the first individual and the second individual is captured and a consensual sex affirmation application code is developed utilizing a code generation module to integrate photos, videos and audio with video and biometric functionality. Further the system displays back the captured selfie photo of the first individual and the second individual and enables the first individual and the second individual to accept or reject the selfie photo. The system provides an option to retake the selfie photo until the first individual and the second individual accepts the photo. The system saves the selfie photo in the central database as soon as the first individual and the second individual accept the photo. Further a declaration module allows the first individual and the second individual to provide signatures by means of a human touch or a device stylus tool and select the continue button to move forward. The process ends by storing all the plurality of contact details of the first individual and the second individual in the central database and the system electronically sends a secured password protected consensual sex affirmation acknowledgment file to both the first individual and the second individual utilizing a consensual sex affirmation sending module. The consensual sex affirmation software application allows the first individual and the second individual to view the electronically received consensual sex affirmation acknowledgment file utilizing a consensual sex affirmation storage module after importing to the at least one portable communication device. The electronically received consensual sex affirmation acknowledgment file includes the plurality of contact details, the signature and the selfie photo submitted by the first individual and the second individual.

A first objective of the present invention is to provide a consensual sex affirmation storing system to create an electronically stored sex affirmation consent between two individuals before engaging in sexual activity.

A second objective of the present invention is to provide a consensual sex affirmation storing system to provide a facility that clarifies any ambiguity regarding the question of affirmative consent to sexual activity.

A third objective of the present invention is to provide a simple and easy way for users to create new affirmations, view previously stored affirmations and to navigate through resource links to various organizations or websites offering healthcare information.

A fourth objective of the present invention is to allow users to create a memorialized affirmation which will be stored within the application if internet connectivity is unavailable.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is an exemplary computer network environment that is used in a system and method for creating an electronically stored consensual sex affirmation between two individuals before engaging in sexual activity in accordance with a preferred embodiment of the present invention;

FIG. 2 is a high-level block diagram of a consensual sex affirmation storing system illustrated in the computing environment of FIG. 1 in accordance with a preferred embodiment of the present invention;

FIGS. 3A-3B are operational flowcharts illustrating a method for creating an electronically stored consensual sex affirmation in accordance with the present invention;

FIG. 4 is a screenshot illustrating a welcome screen of a consensual sex affirmation software application of the present invention;

FIG. 5 is a screenshot illustrating a plurality of terms of the consensual sex affirmation acknowledgement process for the first individual and the second individual in accordance with the present invention;

FIG. 6 is a screenshot illustrating authorization of whether the first individual is the owner of the at least one electronic portable communication device in accordance with the present invention;

FIG. 7 is a screenshot illustrating a consensual sex affirmation contact information form for the first individual and the second individual to which a plurality of contact details has to be submitted in accordance with the present invention;

FIG. 8 is a screenshot illustrating a selfie photo taken by the first individual and the second individual during the verification process in accordance with the present invention;

FIG. 9 and FIG. 10 are screenshots illustrating signatures provided by the first individual and the second individual as a consent for creating an electronically stored sex affirmation in accordance with the present invention;

FIG. 11 is a screenshot illustrating a declaration statement at the end of the method of creating an electronically stored consensual sex affirmation in accordance with the present invention;

FIG. 12 and FIG. 13 are screenshots illustrating an electronically received consensual sex affirmation acknowledgement file by the first individual and the second individual and password prompting for the opening of the consensual sex affirmation acknowledgement file in accordance with the present invention; and

FIG. 14 is a screenshot illustrating the contents of the consensual sex affirmation acknowledgement file electronically received by the first individual and the second individual in accordance with the present invention.

### DETAILED DESCRIPTION OF THE PREFERRED EMBODIMENT

In the following discussion that addresses a number of embodiments and applications of the present invention, reference is made to the accompanying drawings that form a part hereof, and in which is shown by way of illustrating specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. The invention will now be described with reference to the accompanying drawing which does not limit the scope and the ambit of the invention.

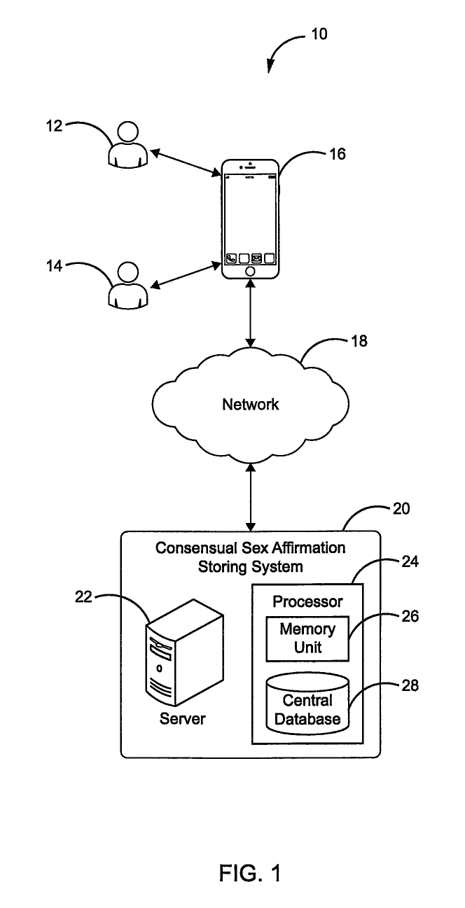

FIG. 1 is an exemplary computer network environment 10 that is used in a system and method for creating an electronically stored consensual sex affirmation between two individuals before engaging in sexual activity in accordance with a preferred embodiment of the present invention. The computer network environment 10 includes a communication network 18 such as the Internet which interconnects a consensual sex affirmation storing system 20 and at least one electronic portable communication device 16 associated with an individual 12,14. The at least one electronic portable communication device 16 is selected from a group consisting of: a smart phone, a laptop, a tablet computer and a hand-held digital media communication device.

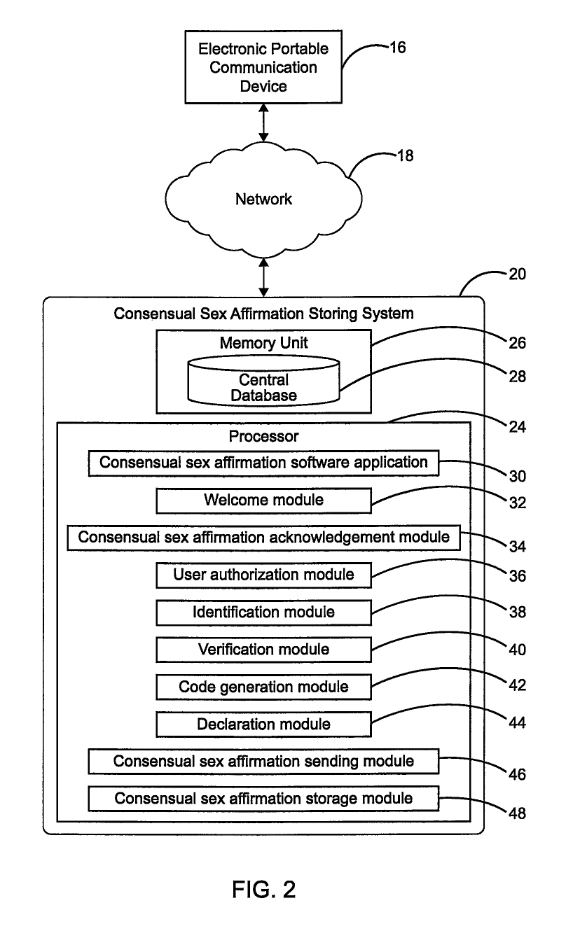

Referring to FIG. 2, a high-level block diagram of a consensual sex affirmation storing system 20 illustrated in the computing environment of FIG. 1 in accordance with a preferred embodiment of the present invention is depicted. The consensual sex affirmation storing system 20 resides on a central computer having a processor 24 installed with a consensual sex affirmation software application 30 and coupled with a memory unit 26 integrated with a central database 28. The consensual sex affirmation software application 30 may be a mobile application, a desktop computer application, an embedded software program, or any other type of software application that runs on the processor 24 of the central computer. In one embodiment of the present invention, the central computer is a server system. The consensual sex affirmation storing system further comprising, a welcome module 32, a consensual sex affirmation acknowledgement module 34, a user authorization module 36, an identification module 38, a verification module 40, a code generation module 42, a declaration module 44, a consensual sex affirmation sending module 46, and a consensual sex affirmation storage module 50. The central computer executes a computer readable program code embodied in a non-transitory computer-readable medium. The computer readable program code includes a set of instructions for executing a method for creating an electronically stored consensual sex affirmation between two individuals prior to the sexual activity.

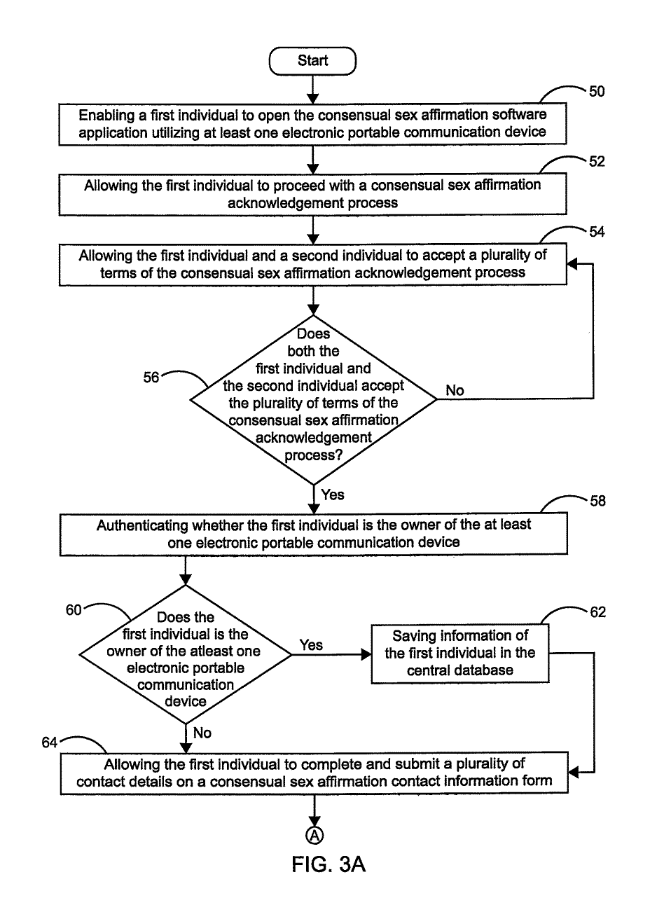

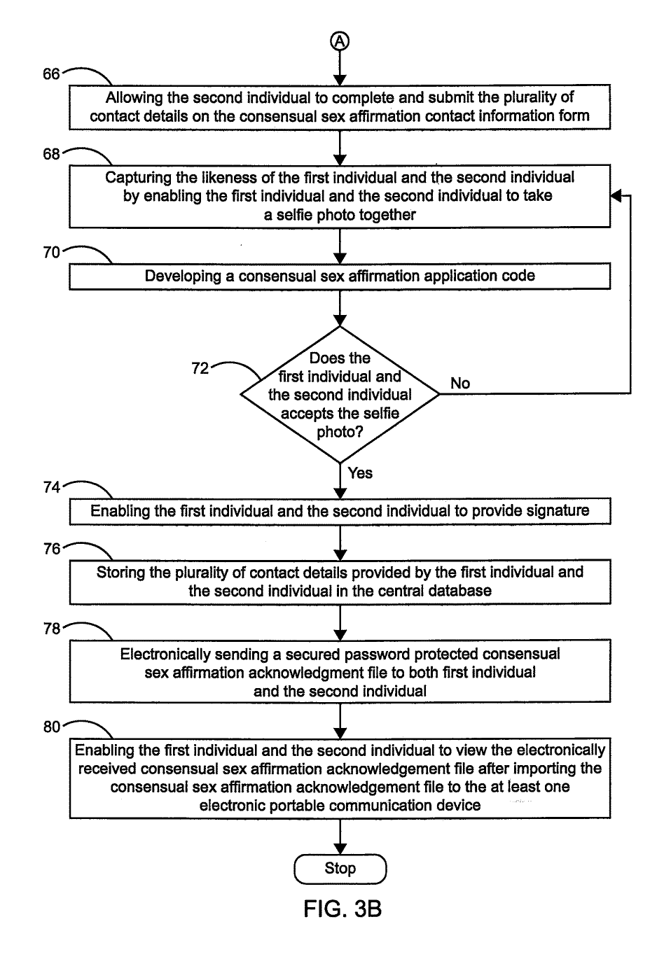

FIGS. 3A-3B are operational flowcharts illustrating a method for creating an electronically stored consensual sex affirmation in accordance with the present invention. The method consists of multiple steps requiring the input of each participating individuals, including, but not limited to, affirmation of the acceptance of each individual, identification and verification of the individuals and consenting signature or similar journaling of each individuals. The method initiates by enabling a first individual to open the consensual sex affirmation software application 30 utilizing a welcome module 32 through at least one electronic portable communication device 16 as indicated in block 50. A continue button on a welcome screen of the consensual sex affirmation software application 30 leads the first individual to the consensual sex affirmation acknowledgement process as illustrated in block 52. Referring to block 54, the first individual and a second individual accepts a plurality of terms to move forward with the process utilizing a consensual sex affirmation acknowledgement module 34. As soon as the first individual and the second individual accepts the plurality of terms of the consensual sex affirmation acknowledgement process, an authorization module authorizes whether the first individual is the owner of the at least one electronic portable communication device and permanently stores a plurality of the contact details submitted by the first individual in the at least one electronic portable communication device 16 to auto populate a consensual sex affirmation contact information form in future, if the first individual is the owner of the at least one electronic portable communication device 16 as depicted in blocks 56, 58, 60 and 62. Further in block 64 and 66, an identification module 38 allows the first individual and a second individual to input the plurality of contact details on the consensual sex affirmation contact information form. The plurality of contact details of the first individual and the second individual preferably comprises: first name, last name, gender, date of birth, mobile number and email address of the first individual and the second individual respectively. A verification module 40 captures the likeness of the first individual and the second individual by enabling the first individual and the second individual to take a selfie photo together and enables the first individual and the second individual to retake the selfie photo, if the first individual and the second individual reject the previously taken selfie photo as illustrated in blocks 68, 72 and 74. Later in block 72, a code generation module 42 develops a consensual sex affirmation application code to integrate photos, videos, audio with video and biometric functionality. Further, a declaration module 44 allows the first individual and the second individual to provide signatures by means of a human touch or a device stylus tool and select the continue button to move forward as shown in block 74. The process ends by storing all the plurality of contact details of the first individual and the second individual in the central database and the system electronically sends a secured password protected consensual sex affirmation acknowledgment file to both the first individual and the second individual utilizing a consensual sex affirmation sending module 46 as indicated in block 76 and 78. The consensual sex affirmation software application 30 allows the first individual and the second individual to view the electronically received consensual sex affirmation acknowledgment file utilizing a consensual sex affirmation storage module 50 after importing to the at least one portable communication device according to block 80.

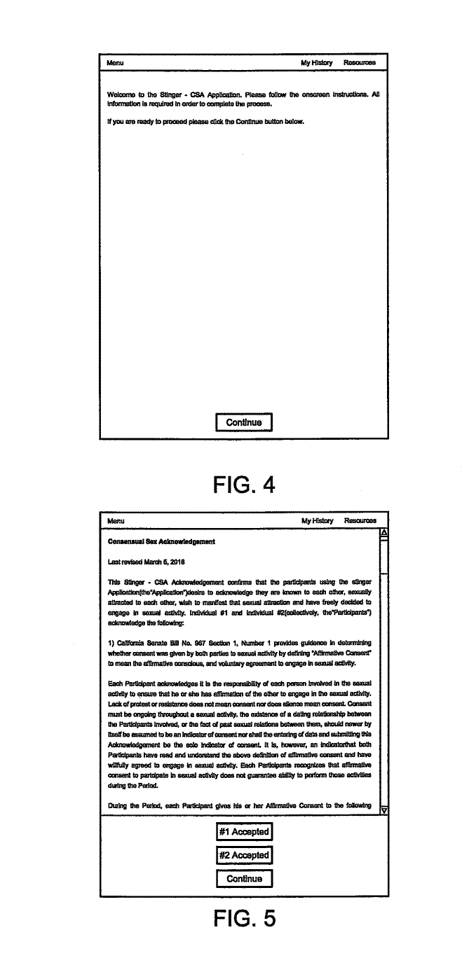

FIG. 4 is a screenshot illustrating the welcome screen of a consensual sex affirmation software application 30 of the present invention. The welcome screen includes a navigation bar at the top having options such as menu, my history area and resources area. The first individual 12 has to click the continue button at the bottom of the page to proceed with the consensual sex affirmation acknowledgement process.

FIG. 5 is a screenshot illustrating a plurality of terms of the consensual sex affirmation acknowledgement process for the first individual 12 and the second individual 14 in accordance with the present invention. Both the first individual 12 and the second individual 14 have to accept the plurality of terms of the consensual sex affirmation acknowledgement process before they can continue or move forward with the process. Required buttons prevent the first individual 12 and the second individual 14 from moving forward without both the individuals 12, 14 accepting the consensual sex affirmation acknowledgement.

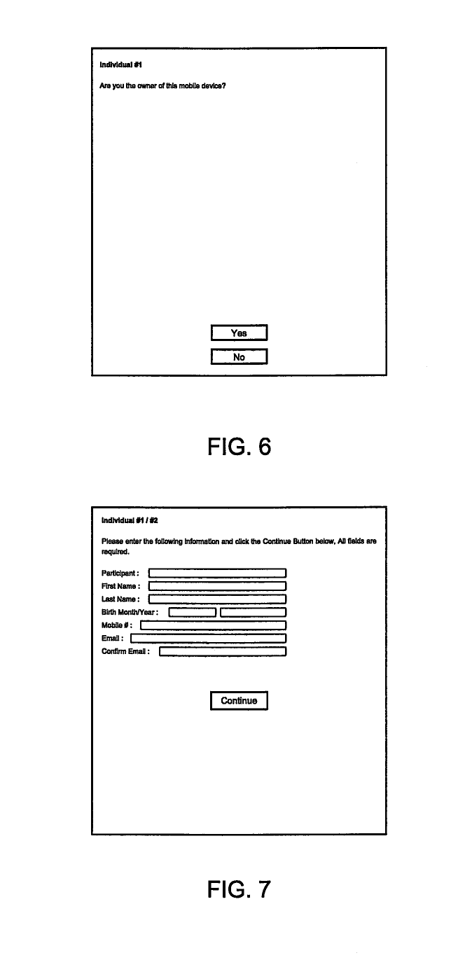

FIG. 6 is a screenshot illustrating authorization of whether the first individual 12 is the owner of the at least one electronic portable communication device 16 in accordance with the present invention. If the first individual 12 is the owner of the at least one electronic portable communication device 16, the contact details submitted by the first individual 12 is permanently stored in the at least one electronic portable communication device 16 to auto populate the consensual sex affirmation contact information form in future or else continue as a one-time guest entry and the data will not be saved for future use.

FIG. 7 is a screenshot illustrating a consensual sex affirmation contact information form for the first individual 12 and the second individual 14 to which a plurality of contact details has to be submitted in accordance with the present invention. Both the first individual 12 and the second individual 14 has to complete and submit a plurality of contact details includes but not limited to, first name, last name, gender, date of birth, contact number and email id.

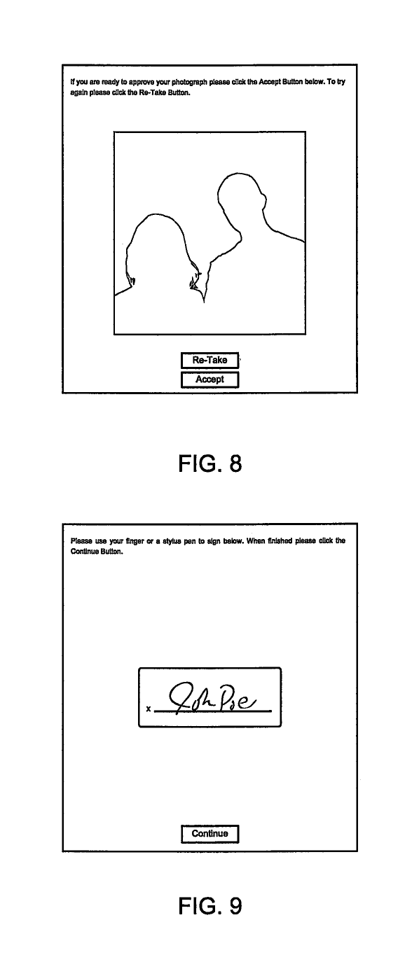

FIG. 8 is a screenshot illustrating a selfie photo taken by the first individual 12 and the second individual 14 during the verification process in accordance with the present invention. In the verification process, the consensual sex affirmation software application 30 captures the likeness of the first individual 12 and the second individual 14 by enabling the first individual 12 and the second individual 14 to take a selfie photo together. The application will then display back the captured photo and the individuals 12, 14 have the option of accepting the image and proceeding on or they can retake the photo multiple times until desired result. Once the accept button is selected the image is then saved.

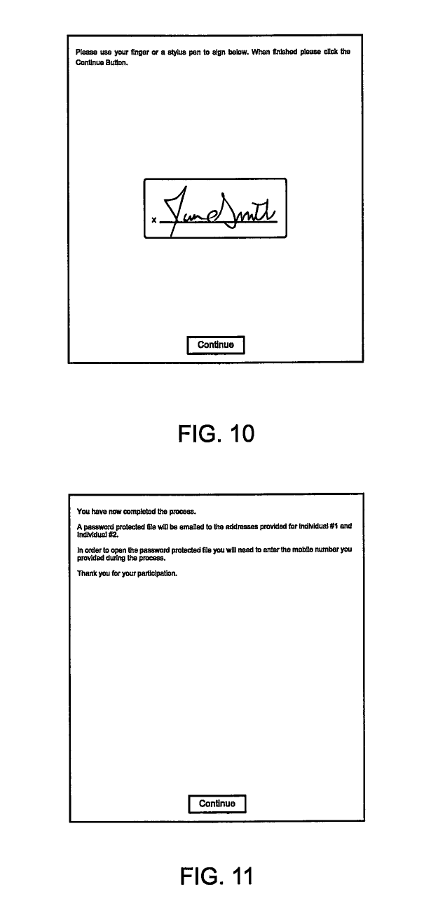

FIG. 9 and FIG. 10 are screenshots illustrating signatures provided by the first individual 12 and the second individual 14 as consent for creating an electronically stored sex affirmation in accordance with the present invention. Once the signature button of the consensual sex affirmation software application 30 is selected by the first individual 12 and the second individual 14, the application 30 continues to capture the signature by means of human touch or a device stylus tool.

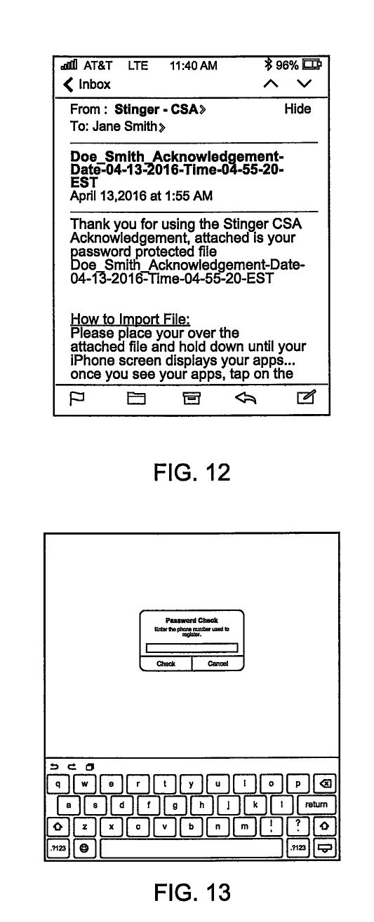

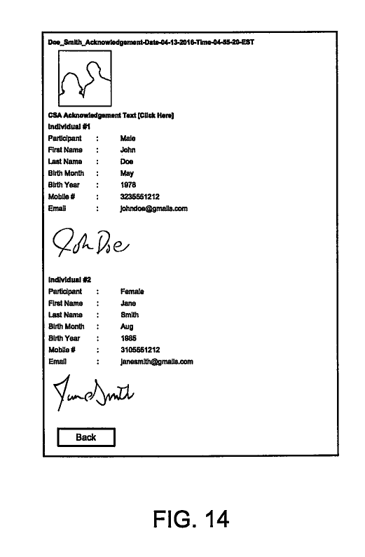

FIG. 11 is a screenshot illustrating a declaration statement at the end of the method of creating an electronically stored consensual sex affirmation in accordance with the present invention. Once the first individual 12 clicks the continue button below the declaration statement, a secured password protected consensual sex affirmation acknowledgement file is electronically sent to both the first individual 12 and the second individual 14 which contains all the information submitted by the first individual 12 and the second individual 14. FIG. 12 and FIG. 13 are screenshots illustrating a consensual sex affirmation acknowledgement file electronically received by the first individual 12 and the second individual 14 and password prompting for the opening of the consensual sex affirmation acknowledgement file in accordance with the present invention. Once the electronically received consensual sex affirmation acknowledgement file is imported to the at least one electronic portable communication device 16, it can be opened and viewed inside the consensual sex affirmation software application 30. The electronic transmission also contains an additional PDF file on how to import the attached secured consensual sex affirmation acknowledgement file. The imported consensual sex affirmation acknowledgement file is viewable by opening the consensual sex affirmation software application 30 and accessing the “My history” area located on the navigation bar on the top of the welcome screen. While selecting the “My history” option a list is generated containing any and all the consensual sex affirmation acknowledgements that have been imported by the individuals. FIG. 14 is a screenshot illustrating the contents of the electronically received consensual sex affirmation acknowledgement file by the first individual 12 and the second individual 14 in accordance with the present invention. The electronically received consensual sex affirmation acknowledgement file includes the plurality of contact details, the signature and the selfie photo submitted by the first individual and the second individual.

It should also be understood that the logic code, programs, modules, processes, methods and the order in which the respective processes of each method performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that may contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that may communicate, propagate, or transport a program for use by or in connection with an instruction execution system, apparatus, or device.

Program code embodied on a computer readable storage medium may be transmitted using any appropriate medium, including but not limited to wireless, wire line, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, may be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that may direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowcharts and block diagrams in the figures illustrate the architecture, functionality, and operation of possible implementations of systems, methods and computer program products that are non-transitory according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here; changes and modifications may be applied to said embodiments without limiting or departing from the generally intended scope. These and various other adaptations and combinations of the embodiments provided here are within the scope of the disclosed subject matter as defined by the claims and their full set of equivalents.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A method for creating an electronically stored consensual sex affirmation using a non-transitory computer program product being embodied in a computer readable medium, the method comprising:
a) enabling a first individual to open a consensual sex affirmation software application utilizing a welcome module;
b) allowing the first individual and a second individual to accept a plurality of terms of the consensual sex affirmation acknowledgement process utilizing a consensual sex affirmation acknowledgement module;
c) authorizing whether the first individual is the owner of the at least one electronic portable communication device utilizing a user authorization module;
d) allowing the first individual and the second individual to complete and submit a plurality of contact details on a consensual sex affirmation contact information form utilizing an identification module;
e) capturing the likeness of the first individual and the second individual by enabling the first individual and the second individual to take a selfie photo together utilizing a verification module;
f) developing a consensual sex affirmation application code utilizing a code generation module;
g) enabling the first individual and the second individual to provide signature utilizing a declaration module;
h) storing the plurality of contact details provided by the first individual and the second individual in the central database;
i) electronically sending a secured password protected consensual sex affirmation acknowledgment file to both the first individual and the second individual utilizing a consensual sex affirmation sending module; and
j) enabling the first individual and the second individual to view the electronically received consensual sex affirmation acknowledgement file utilizing a consensual sex affirmation storage module.

2. The method of claim 1 wherein the plurality of contact details of the first individual and the second individual preferably comprises: first name, last name, gender, date of birth, mobile number and email address.

3. The method of claim 1 wherein the plurality of the contact details submitted by the first individual is permanently stored in the at least one electronic portable communication device to auto populate the consensual sex affirmation contact information form in future, if the user authorization module authorizes the first individual as the owner of the at least one electronic portable communication device.

4. The method of claim 1 wherein consensual sex affirmation application code integrates photos, videos, audio with video and biometric functionality.

5. The method of claim 1 wherein the signature of the first individual and the second individual is captured utilizing human touch or a device stylus tool.

6. The method of claim 1 wherein the electronically received consensual sex affirmation acknowledgement file includes the plurality of contact details, the signature and the selfie photo submitted by the first individual and the second individual.

7. The method of claim 1 wherein the verification module enables the first individual and the second individual to retake the selfie photo, if the first individual and the second individual reject the previously taken selfie photo.

8. The method of claim 1 wherein the consensual sex affirmation storage module imports the consensual sex affirmation acknowledgement file to the at least one electronic portable communication device.

9. A system for creating an electronically stored consensual sex affirmation, the system comprising:
at least one electronic portable communication device;
a consensual sex affirmation storing system being in communication with at least one electronic portable communication device via a communication network, the consensual sex affirmation storing system resides on a central computer having a processor installed with a consensual sex affirmation software application and coupled with a memory unit integrated with a central database, the consensual sex affirmation storing system comprising:
a welcome module, at the processor, configured to enable a first individual to open the consensual sex affirmation software application utilizing the at least one electronic portable communication device;
a consensual sex affirmation acknowledgement module, at the processor, configured to allow the first individual and a second individual to accept a plurality of terms of a consensual sex affirmation acknowledgement process;
a user authorization module, at the processor, configured to authorize whether the first individual is the owner of the at least one electronic portable communication device;
an identification module, at the processor, configured to allow the first individual and the second individual to complete and submit a plurality of contact details on a consensual sex affirmation contact information form;
a verification module, at the processor, configured to capture the likeness of the first individual and the second individual by enabling the first individual and the second individual to take a selfie photo together;
a code generation module, at the processor, configured to develop a consensual sex affirmation application code to integrate photos, videos, audio with video and biometric functionality;
a declaration module, at the processor, configured to enable the first individual and the second individual to provide signature utilizing human touch or a device stylus tool;
a consensual sex affirmation sending module, at the processor, configured to electronically send a secured password protected consensual sex affirmation acknowledgment file to both the first individual and the second individual; and
a consensual sex affirmation storage module, at the processor, configured to enable the first individual and the second individual to view the electronically received consensual sex affirmation acknowledgement file after importing the consensual sex affirmation acknowledgement file to the at least one electronic portable communication device.

10. The system of claim 9 wherein the at least one electronic portable communication device is selected from a group consisting of: a smart phone, a laptop, a tablet computer and a hand-held digital media communication device.

11. The system of claim 9 wherein the plurality of the contact details submitted by the first individual is permanently stored in the at least one electronic portable communication device to auto populate the consensual sex affirmation contact information form in future, if the user authorization module authorizes the first individual as the owner of the at least one electronic portable communication device.

12. The system of claim 9 wherein the plurality of contact details of the first individual and the second individual preferably comprises: first name, last name, gender, date of birth, mobile number and email address.

13. The system of claim 9 wherein the electronically received consensual sex affirmation acknowledgement file includes the plurality of contact details, the signature and the selfie photo submitted by the first individual and the second individual.

14. The system of claim 9 wherein the verification module enables the first individual and the second individual to retake the selfie photo, if the first individual and the second individual reject the previously taken selfie photo;

15. A non-transitory computer-readable medium having a computer-readable program code embodied therein which when executed by a computer having a processor installed with a consensual sex affirmation software application and coupled with a memory unit integrated with a central database causes the processor to perform the following steps:
a) enabling a first individual to open the consensual sex affirmation software application utilizing a welcome module through at least one electronic portable communication device;
b) allowing the first individual and a second individual to accept a plurality of terms of the consensual sex affirmation acknowledgement process utilizing a consensual sex affirmation acknowledgement module;
c) authorizing whether the first individual is the owner of the at least one electronic portable communication device utilizing a user authorization module;
d) allowing the first individual to complete and submit a plurality of contact details on a consensual sex affirmation contact information form utilizing an identification module through at least one electronic portable communication device;
e) allowing the second individual to complete and submit the plurality of contact details on the consensual sex affirmation contact information form utilizing the identification module through at least one electronic portable communication device;
f) capturing the likeness of the first individual and the second individual by enabling the first individual and the second individual to take a selfie photo together utilizing a verification module;
g) developing a consensual sex affirmation application code utilizing a code generation module to integrate photos, videos, audio with video and biometric functionality;
h) enabling the first individual and the second individual to provide signature utilizing a declaration module through a human touch or a device stylus tool;
i) storing the plurality of contact details provided by the first individual and the second individual in the central database;
j) electronically sending a secured password protected consensual sex affirmation acknowledgment file to both first individual and the second individual utilizing a consensual sex affirmation sending module; and
k) enabling the first individual and the second individual to view the electronically received consensual sex affirmation acknowledgement file utilizing a consensual sex affirmation storage module, after importing the consensual sex affirmation acknowledgement file to the at least one electronic portable communication device.

16. The non-transitory computer-readable medium of claim 15 wherein the plurality of contact details of the first individual preferably comprises: first name, last name, gender, date of birth, mobile number and email address.

17. The non-transitory computer-readable medium of claim 15 wherein the plurality of contact details of the second individual preferably comprises: first name, last name, gender, date of birth, mobile number and email address.

18. The non-transitory computer-readable medium of claim 15 wherein the plurality of the contact details submitted by the first individual is permanently stored in the at least one electronic portable communication device to auto populate the consensual sex affirmation contact information form in future, if the user authorization module authorizes the first individual as the owner of the at least one electronic portable communication device.

19. The non-transitory computer-readable medium of claim 15 wherein the verification module enables the first individual and the second individual to retake the selfie photo, if the first individual and the second individual rejects the previously taken selfie photo.

20. The non-transitory computer-readable medium of claim 15 wherein the electronically received consensual sex affirmation acknowledgement file includes the plurality of contact details, the signature and the selfie photo submitted by the first individual and the second individual.
